(19) United States
(12) Patent Application Publication
(10) Pub. No.: US 2025/0054189 A1
(43) Pub. Date: Feb. 13, 2025

(54) POSE ESTIMATION METHOD FOR MOVABLE PLATFORM, MOVABLE PLATFORM, AND STORAGE MEDIUM

(71) Applicant: SZ DJI TECHNOLOGY CO., LTD., Shenzhen (CN)

(72) Inventors: You ZHOU, Shenzhen (CN); Ce XIONG, Shenzhen (CN); Xi CHEN, Shenzhen (CN)

(21) Appl. No.: 18/837,595

(22) PCT Filed: Jan. 28, 2022
(86) PCT No.: PCT/CN2022/074678

§ 371 Date: Aug. 10, 2024

(51) Int. Cl. G06T 7/80; G06T 7/73

(52) U.S. Cl. CPC G06T 7/80; G06T 7/73

(57) ABSTRACT

A pose estimation method includes obtaining an observation image of a second sensor of a movable platform. The movable platform further includes a first sensor mounted at the movable platform through a mounting member. An observation range of the second sensor includes the mounting member. The method further includes determining an image area where the mounting member is located in the observation image, and determining a relative pose relationship between the first sensor and the second sensor based on a pixel position of the image area.

### TECHNICAL FIELD

The present disclosure relates to the field of computer vision and, more specifically, to a pose estimation method for a movable platform, a movable platform, and a storage medium.

### BACKGROUND

Movable platforms, such as unmanned aerial vehicles, robots, mobile trolleys, mobile ships, underwater mobile vehicles or the like, play a very important role in many fields such as film and television, search and rescue, police, military, etc., which can adapt to complex environments. The movable platform generally collects surrounding images through the camera mounted thereon. The movement of the movable platform is generally controlled based on the depth information determined using the images to avoid hitting obstacles.

Some movable platforms use binocular vision systems to obtain depth information of objects in the field of view. That is, two cameras are used to collect images together, and then a series of determinations are used to determine the distance of a specific point based on the parallax between the images obtained by the two cameras. In order to make the observation distance far enough, that is, the depth information determined for distant objects is accurate enough, the parallax between the two images obtained by the two cameras needs to be large enough. That is, the distance between the two cameras needs to be large enough.

In some cases, the camera can be installed at an arm, the end of a bracket, or at a position far away from the movable platform body, extending from the movable platform itself, such that there is a sufficient distance between the two cameras on the movable platform. However, in order to achieve multi-directional observation and obstacle avoidance, a group of cameras need to be installed at the movable platform to face each of multiple directions. In order to avoid errors in the determined depth information, the camera at the movable platform needs to maintain its relative pose unchanged. That is, the camera needs to be fixedly connected to the body of the movable platform using a sturdy bracket, that is, a rigid connection. The movable platform implemented using this arrangement has a relatively large body, which is not easy to carry, and the bracket needs to be kept in a strict pose, which also makes it difficult to assemble and maintain.

### SUMMARY

The present disclosure provides a pose estimation method for a movable platform, the movable platform, and a storage medium.

In accordance with a first aspect of the disclosure, there is provided a pose estimation method for a movable platform. The movable platform includes a first sensor and a second sensor, the first sensor being disposed at the movable platform through a first mounting member, and an observation range of the second sensor including the first mounting member. The method includes obtaining an observation image of the second sensor; determining an image area where the first mounting member is located in the observation image of the second sensor; and determining a relative pose relationship between the first sensor and the second sensor based on a pixel position of the image area.

In accordance with a second aspect of the disclosure, there is provided a pose estimation method for a movable platform. The movable platform includes a first sensor and a second sensor, observation ranges of the first sensor and the second sensor partially overlap. The method includes obtaining a first observation image set, the first observation image set including observation images taken by the first sensor and the second sensor at the same time; obtaining a second observation image set taken by the second sensor, the second observation image set including a plurality of observation images taken by the second sensor at different times; and determining a relative pose relationship between the first sensor and the second sensor based on the first observation image set and the second observation image set.

In accordance with a third aspect of the disclosure, there is provided a movable platform including a body; an obstacle avoidance assembly mounted at the body, the obstacle avoidance assembly including a plurality of visual sensors, the visual sensors being distributed in a polyhedron in space, each plane of the polyhedron having at least one of the visual sensors, two visual sensors on different planes constituting a binocular vision system, an observation range of the binocular vision system being the observation range in which the two vision sensors overlap, wherein the two visual sensors of the binocular vision system are a first sensor and a second sensor, and the first sensor is disposed at the body through a first mounting member, an observation range of the second sensor including the first mounting member; and a processor, the processor being configured to obtain an observation image of the second sensor; determine an image area where the first mounting member is located in the observation image of the second sensor; and determine a relative pose relationship between the first sensor and the second sensor based on a pixel position of the image area.

In accordance with a fourth aspect of the disclosure, there is provided a movable platform including a body; an obstacle avoidance assembly mounted at the body, the obstacle avoidance assembly including a plurality of visual sensors, the visual sensors being distributed in a polyhedron in space, each plane of the polyhedron having at least one of the visual sensors, two visual sensors on different planes constituting a binocular vision system, an observation range of the binocular vision system being the observation range in which the two vision sensors overlap, wherein the two visual sensors of the binocular vision system are a first sensor and a second sensor; and a processor, the processor being configured to: obtain a first observation image set, the first observation image set including observation images taken by the first sensor and the second sensor at the same time; obtain a second observation image set taken by the second sensor, the second observation image set including a plurality of observation images taken by the second sensor at different times; and determine a relative pose relationship between the first sensor and the second sensor based on the first observation image set and the second observation image set.

In accordance with a fifth aspect of the disclosure, there is provided a computer-readable storage medium, wherein the readable storage medium stores computer instructions, and the computer instructions, when executed, implement following operations: obtaining an observation image of the second sensor; determining an image area where the first mounting member is located in the observation image of the second sensor; and determining a relative pose relationship between the first sensor and the second sensor based on a pixel position of the image area.

In accordance with a sixth aspect of the disclosure, there is provided a computer-readable storage medium, wherein the readable storage medium stores computer instructions, and the computer instructions, when executed, implement following operations: obtaining a first observation image set, the first observation image set including observation images taken by the first sensor and the second sensor at the same time; obtaining a second observation image set taken by the second sensor, the second observation image set including a plurality of observation images taken by the second sensor at different times; and determining a relative pose relationship between the first sensor and the second sensor based on the first observation image set and the second observation image set.

As seen from the technical solutions provided by embodiments of the disclosure, the relative pose relationship between the first sensor and the second sensor can be determined using the pixel positions of the first sensor in observation images taken by the second sensor. Alternatively, the relative pose relationship between the first sensor and the second sensor can be determined using an observation image set captured by the first sensor and the second sensor at the same time and a second observation image set comprising of images taken by the second sensor at different times. Therefore, the solution in the disclosure is applicable to movable platforms using either rigid or non-rigid structures. Since the relative pose relationship between the two cameras can be determined in real-time from the images captured by the cameras, even if the relative pose relationship between the two cameras changes, the depth information of objects can be determined by determining the real-time relative pose information of the two cameras, which has a relatively high accuracy. Consequently, in this disclosure, the mounts for mounting the cameras at the movable platform do not need to maintain a strict attitude, which reduces the difficulty of assembly and maintenance. Furthermore, non-rigid mounts, such as foldable mounts, can be used instead of fixed mounts, thereby reducing the size of the movable platform and making it more portable.

### BRIEF DESCRIPTION OF THE DRAWINGS

In order to more clearly illustrate the technical solutions in the embodiments of the present application, the drawings used in the description of the embodiments are briefly introduced below. The drawings described below are only some embodiments of the present application. For people of ordinary skill in the art, other drawings can be obtained based on these drawings without creative work.

FIG. 1 illustrates a structural diagram of a movable platform according to some embodiments of the present disclosure;

FIG. 2 illustrates a flowchart of a pose estimation method of a movable platform according to some embodiments of the present disclosure; and

FIG. 3 illustrates a flowchart of a pose estimation method of a movable platform according to some embodiments of the present disclosure.

### DETAILED DESCRIPTION OF THE EMBODIMENTS

The technical solutions and technical features encompassed in the exemplary embodiments of the present disclosure will be described in detail in conjunction with the accompanying drawings in the exemplary embodiments of the present disclosure. Apparently, the described exemplary embodiments are part of embodiments of the present disclosure, not all of the embodiments. Based on the embodiments and examples disclosed in the present disclosure, all other embodiments obtained by those of ordinary skill in the art without creative work shall fall within the protection scope of the present disclosure.

Using a foldable bracket to connect the camera to the body of the movable platform, i.e., a non-rigid connection, can reduce the overall size of the movable platform. In this way, the inconvenience in carrying caused by the rigid connection bracket of the camera can be improved. If this design is adopted, due to the non-rigid connection, the bracket may also be equipped with a motor for driving the movable platform to move. During the use of the movable platform, the shape and position of the bracket may be deformed due to the vibration caused by the use of the motor and temperature changes, that is, the position of the camera will change. However, the depth information needs to be determined based on the relative pose between the two cameras. Generally, the relative pose between the cameras used to determine the depth information is measured during the production process, but when in use, the pose of the camera changes, and the relative pose between the two cameras will also change. In this way, the original relative pose is no longer accurate such that the determined depth information is also inaccurate, which will affect the observation, obstacle avoidance, and movement of the movable platform. The following technical solutions not only can make the movable platform carrying the non-rigidly connected camera practically applicable, but also can be applied to the conventional movable platform with rigidly connected cameras.

In the embodiments of the present disclosure, a sensor may be an image sensor that can obtain images within a certain range, which can be a camera, a camera module, or just an image sensor chip in a camera. In some embodiments, in order to obtain a larger field of view, the sensor may be a fisheye camera with a viewing angle exceeding 180°, such as 220°.

In the embodiments of the present disclosure, a mounting member may refer to an intermediate structure connected between the sensor and the movable platform, or a combination of multiple intermediate structures. In some embodiments, in addition to the mounting member, there may be other intermediate structures between the sensor and the camera. The sensor and the mounting member may be directly or indirectly connected, and the mounting member and the movable platform body may also be directly or indirectly connected. In some embodiments, the mounting member may be a bracket or an arm. In some embodiments, when the sensor is an image sensor chip, the mounting member may also include other mechanical structures of the camera. In some embodiments, the mounting member may be one or more of a foldable structure, a retractable structure and a rotatable structure, or have other structures, which can cause a relative post change between the sensor and the movable platform body.

In the embodiments of the present disclosure, a non-rigid connection may refer to a non-fixed connected. That is, the relative pose between the sensor and the movable platform, such as distance and direction, will change. In contract, a rigid connection may refer to a fixed connection with unchanging relative pose.

In the embodiments of the present disclosure, the movable platform may include two or more sensors. In some embodiments, the connection between the sensor of the movable platform and the movable platform body may be a non-rigid connection or a rigid connection, and different sensors can use different connection methods. In some embodiments, all sensors of the movable platform may be of the same type, or may include sensors of multiple types.

In the embodiments of the present disclosure, the visual system including multiple sensors on the movable platform can be used for obstacle avoidance of the movable platform. Therefore, the structure including the sensors can be regarded as an obstacle avoidance component installed at the movable platform body. Each of the visual sensors may be distributed in a polyhedron in space. Each plane of the polyhedron may be distributed with at least one visual sensor, and two visual sensors on different planes may constitute a binocular vision system. The observation range of the binocular vision system may be the observation range in which the two visual sensors overlap.

In some embodiments, in order to obtain the field of view of the movable platform in six directions, two sensors may be set in each of the six directions to form a binocular vision system in six directions. However, this sensor arrangement requires connecting twelve sensors to the movable platform, which results in high production cost and makes the movable platform larger and less portable. Therefore, in some embodiments, in the horizontal direction of the movable platform, only one sensor may be set at each of the four endpoints of the two diagonal lines, and the four sensors may be sensors with a relatively large viewing angle, such as fisheye cameras. Each sensor's field of view can cover two directions adjacent to its endpoint. In this way, the need to set up two sensors in each of the four directions to form a binocular vision system in the four directions can be eliminated, thereby reducing the cost of four sensors. In addition, in some embodiments, the orientation of the four sensors at the four endpoints may not be horizontal, but may be at a certain angle, such as 45°, to the horizontal plane where the movable platform is located, in an upward or downward direction. In this way, the observation range of these four sensors not only covers the four directions of front, back, left, and right on the horizontal plane, but also covers the two directions of up and down on the horizontal plane. In some embodiments, the sensors at the two endpoints of one diagonal line may face obliquely upward, while the sensors at the two endpoints of the other diagonal line may face obliquely downwards, forming a binocular vision system in the upper and lower directions respectively, thereby reducing the cost of the four sensors originally arranged in the up and down directions of the movable platform.

In some embodiments, in order to make the field of view of the movable platform cover all directions of the movable platform, the sensors on the movable platform may also be set to face in different angles such that the sensors on the movable platform are distributed in a polyhedral manner. The plane where all sensors are located, that is, the plane perpendicular to the optical axis of the sensors, can form a close polyhedron. In other words, each plane of the polyhedron is distributed with at least one sensor. Any two sensors on planes in non-opposite directions can form a binocular vision system. These two sensors can be located on the same plane or on different planes, and the observation range of the binocular vision system they constitute is the overlapping area of the observation ranges of the two sensors.

The tetrahedron is the polyhedron with the fewest sides. Therefore, in some embodiments, the polyhedron including the sensors of the movable platform may be a tetrahedron. The movable platform may be provided with at least four sensors, and as long as the planes where the four sensors are located can form a tetrahedron, to realize observation in all directions.

Further, the tetrahedron formed by the sensors of the movable platform may be a regular tetrahedron. Since the range that the sensors can observe is limited, depending on the sensor's viewing angle, the sensor's field of view may have certain blind spots. Generally, the movable platform has a relatively poor field of view at the vertices of the polyhedron including sensors, and is prone to visual blind spots. In particular, when the sum of the angles of the sides adjacent to the vertex at the vertex is relatively small, the visual field of the movable platform in the direction of the vertex is bad, and it is more likely to have a visual blind spot. When the polyhedron is a regular polyhedron, the movable platform can have an optimal field of view under the same number of sensors. That is, the possible visual blind spots are distributed most evenly, avoiding the unavoidable visual blind spots in some directions, which have a greater impact on the obstacle avoidance function of the movable platform.

Two example sensor configurations that can enable the sensors of the movable platform to be distributed in a regular tetrahedron will be described in detail below.

In some embodiments, the movable platform may be of a first configuration. That is, the body of the movable platform can be regarded as a cubic space. Two endpoints of any diagonal line on the upper surface of the cube, and the two endpoints of a diagonal line on the lower surface that is not parallel to the diagonal line can be taken, and these four endpoints can be connected in pairs to form a regular tetrahedron. The movable platform has four sensors, which can be respectively arranged on the four sides of the surfaces of the tetrahedron. That is, a sensor facing obliquely downward can be arranged at each of the left front and right rear of the movable platform, and a sensor facing obliquely upward can be arranged at each of the left rear and right front of the movable platform. Alternatively, a sensor facing obliquely upward can be arranged at each of the left front and right rear of the movable platform, and a sensor facing obliquely downward can be arranged at each of the left rear and right front of the movable platform. The four sensors on the movable platform based on the first configuration have overlapping fields of view between each other, and the overlapping areas correspond exactly to the six sides of the cube. Therefore, the movable platform based on the first configuration can realize observation in all directions of front, back, left, right, up and down.

In some embodiments, the movable platform may be of a second configuration. That is, a wide-angle visual sensor facing upward may be arranged above the movable platform. Three sensors facing obliquely downward can be arranged below the movable platform, and the upper sensor and the three lower sensors can form a regular tetrahedron. Based on the second configuration, the four sensors on the movable platform also have overlapping fields of view between each other such that observation in all direction around the movable platform can be achieved.

In some embodiments, the first configuration of the present disclosure can change to the second configuration through a certain rotation relationship. Similarly, the first configuration described above in the present disclosure can also change to another configuration through a certain rotation relationship. Other configurations not shown in the present disclosure should also be considered as included in the present disclosure. Different configurations have certain differences in the direction of overlapping observation areas, which can be adaptively adjusted based on needs, which is not limited in the embodiments of the present disclosure.

An embodiment of the movable platform of the first configuration above will be described in detail below.

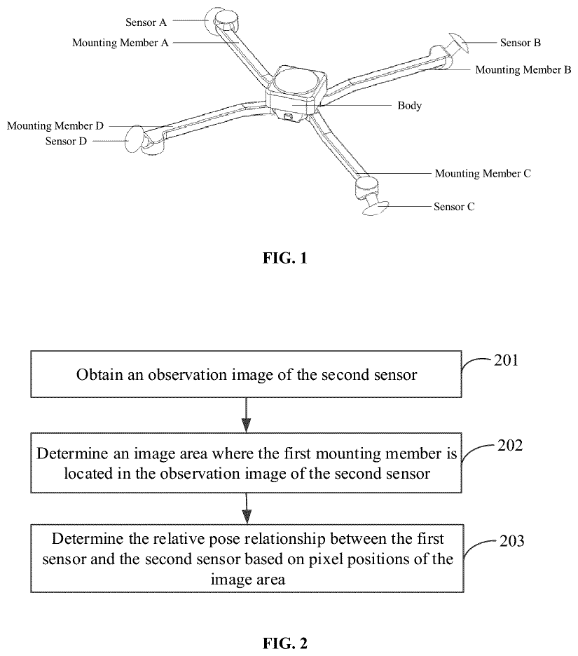

FIG. 1 illustrates a structural diagram of a movable platform according to some embodiments of the present disclosure.

As shown in FIG. 1, the movable platform includes a body, four sensors of sensor A, sensor B, sensor C and sensor D, and four mounting members of mounting member A, mounting member B, mounting member C, and mounting member D.

In FIG. 1, the four mounting members are all foldable arms. Sensor A is non-rigidly connected to the movable platform body through mounting member A, sensor B is non-rigidly connected to the movable platform body through mounting member B, sensor C is non-rigidly connected to the movable platform body through mounting member C, and sensor D is non-rigidly connected to the movable platform body through mounting member D.

In FIG. 1, all four sensors may be fisheye cameras with a viewing angle of more than 180°, and the lens of the four sensors may not be oriented horizontally or vertically, but obliquely at a certain angle to the horizontal plane. In this way, the fields of view of the four sensors can cover six directions of the movable platform of front, back, left, right, up and down.

In some embodiments, sensor A may be located at the front left of the movable platform with its optical axis facing obliquely downward; sensor B may be located in the front right of the movable platform with its optical axis facing obliquely upward; sensor C may be located in the rear right of the movable platform with its optical axis facing obliquely downward; sensor D may be located at the rear left of the movable platform with its optical axis facing obliquely upward.

In some embodiments, the observation areas of sensor A and sensor B may overlap, and the overlapping area may cover the front of the movable platform, together forming a binocular vision system in front of the movable platform. The observation areas of sensor C and sensor D may overlap, and the overlapping area may cover the rear of the movable platform, together forming a binocular vision system behind the movable platform. The observation areas of sensor A and sensor D may overlap, and the overlapping area may cover the left of the movable platform, together forming a binocular vision system on the left side the movable platform. The observation areas of sensor B and sensor C may overlap, and the overlapping area may cover the right of the movable platform, together forming a binocular vision system on the right side the movable platform. The observation areas of sensor B and sensor D may overlap, and the overlapping area may cover the top of the movable platform, together forming a binocular vision system above the movable platform. The observation areas of sensor A and sensor C may overlap, and the overlapping area may cover the bottom of the movable platform, together forming a binocular vision system below the movable platform.

In some embodiments, the mounting member may undergo certain deformation during use. For example, as shown in FIG. 1, the mounting member is a foldable arm, and a sensor is disposed at the arm. That is, in addition to the camera, a motor and a propeller (not shown in FIG. 1) may be provided to drive the movable platform to move. When the movable platform is in use, the motor and propeller will inevitably produce severe vibrations, which may cause the arm to constantly change slightly, resulting in constant slight changes in the relatively pose, that is, the rotation relationship, to constantly change slightly between sensors. However, when matching and determining depth information in a binocular vision system, the requirements for the rotation relationship between sensors are relatively high, and more accurate relative pose values are needed to determine accurate depth information maps. Therefore, after the rotation relationship changes between sensors, it is important to be able to determine the relative pose between sensors in real time for the binocular vision system to determine the depth information.

In the embodiments of the present disclosure, the movable platform may include a first sensor and a second sensor. In some embodiments, there is a certain overlap in the observation ranges of the first sensor and the second sensor, which together constitute a binocular vision system. The first sensor and the second sensor in the present disclosure are used to distinguish two sensors in a binocular vision system, and are not used to specify any specific sensor. For example, in the movable platform shown in FIG. 1, sensor A, sensor B, sensor C, and sensor D can each form a binocular vision system in pair. Therefore, any one of the four sensors can be used as the first sensor, and any one of the remaining three sensors other than the sensor being used as the first sensor can be used as the second sensor. Similarly, a first mounting member and a second mounting member hereinafter are only used to distinguish different mounting members, and are not used to specify any specific mounting member. In particular, a correlation may exist between the first sensor and the first mounting member, and a correlation may exist between the second sensor and the second mounting member.

In the movable platform, the first sensor and the second sensor may be movably connected to the body of the movable platform, that is, first sensor and second sensor may form a non-rigid connection with the body of the movable platform. The relative pose relationship between the first sensor, the second sensor, and the body of the movable platform may change. Therefore, the relative pose relationship between the first sensor and the second sensor may also change.

In some embodiments, the movable platform may include a body, a power assembly, and a plurality of arms. The power assembly may include a motor and a propeller to provide power for the movement of the movable platform. The plurality of arms may extend outward from the body of the movable platform and may be used to support each power assembly such that the movable platform can maintain balance during movement. In particular, the first sensor and the second sensor may be installed at different arms respectively, such that the first sensor and the second sensor can be separated from the body of the movable platform by a certain distance. The first sensor and the second sensor may also maintain a certain distance such that the binocular vision system including the first sensor and the second sensor can have a larger observation range. Since the first sensor and the second sensor are installed at the arm, the power assembly is also installed at the arm, when the movable platform is in use, the power assembly will generate certain vibrations in order to provide power. At this time, the sensor located in the same arm as the power assembly will be affected by the vibration generated by the power assembly, causing the pose of the sensor itself to change.

In some embodiments, the arm may be movably connected to the body of the movable platform. When the arms are in different placement states, the positions of sensors and power assemblies installed at different arms will also change, therefore, the relative position between the first sensor and the second sensor will also change. The placement state of the arm may include a retracted state and an extended state. When the arm is in the retracted state, the end of the arm moves to the position closest to the body of the movable platform, at the same time, and the power assembly and the sensor on the arm also move to the position closest to the body of the movable platform. When the arm is in the extended state, the end of the arm moves to the position farthest from the body of the movable platform, and at the same time, the power assembly and the sensor located on the arm also move to the position farthest from the body of the movable platform. For example, the arm may be a retractable arm. When the arm is extended to the longest position, the arm is in the extended state; when the arm is retracted to the shortest position, the arm is in the retracted state. In another example, the arm may be a foldable arm, and the arm may include multiple sections, each section being connected by a joint. When the joint angles between the various sections of the arm are extended to the maximum, for example, when the joint angle is 180°, the arm is in the extended state. When the joint angles between the various sections of the arm are contracted to the minimum, for example, when the various sections are folded together and the joint angle is 0°, the arm is in the retracted state.

In the movable platform, the first sensor may be disposed at the movable platform through a first mounting member to form a rigid connection or a non-rigid connection with the movable platform. During the use of the movable platform, the first mounting member and the first sensor thereon may be deformed to a certain extent due to the vibration generated by the motor, etc. such that the relative pose relationship between the first sensor and the second sensor changes. Generally, the method of measuring the relative pose relationship between sensors, that is, pose calibration, requires constructing some known targets and structures, and then collecting the image sequence obtained by the sensor through certain controllable motion excitations. At the same time, output of the inertial measurement unit (IMU) is collected. The relative pose relationship between each sensor and the IMU is determined based on the obtained image sequence and IMU output. The relative pose relationship between sensors can be estimated based on the relative pose relationship between each sensor and the IMU. The current pose calibration method requires the sensor to capture images of the calibration target at different relative poses in order to obtain effective observations. At the same time, it is needed to move the IMU in multiple degrees of freedom to generate IMU excitation to ensure the IMU output is valid. The process is rather cumbersome and complicated, requires a certain level of operation, and is not suitable for measuring the relative pose between sensors of a movable platform during normal use.

An embodiment of the present disclosure provides a method for estimating the pose of a movable platform. In this method, the operation is simple and accurate, and it is suitable for measuring the relative pose between sensors of a movable platform during normal use.

When the viewing angle, i.e., the field of view (FOV), of a sensor, i.e., a visual camera, in a binocular vision system of the movable platform is large enough, the sensor can see another sensor in the binocular vision system. For example, in the movable platform shown in FIG. 1, sensor B and sensor C form a binocular vision system, and when the viewing angle of sensor C is large enough, sensor B can be seen in the field of view of sensor C.

An embodiment of the present disclosure provides a method for estimating the pose of a movable platform. When the viewing angle of the second sensor on the movable platform is relatively large and its observation range includes the first mounting member, the relative pose relationship between the two sensors can be determined based on the position change of the first sensor in the image observed by the second sensor.

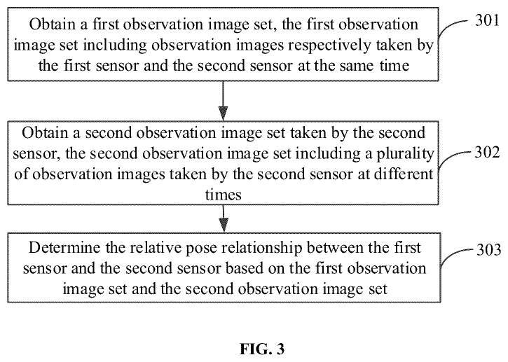

FIG. 2 illustrates a flowchart of a pose estimation method of a movable platform according to some embodiments of the present disclosure. The method will be described in detail below.

At 201, an observation image of the second sensor is obtained.

At 202, an image area where the first mounting member is located in the observation image of the second sensor is determined.

At 203, the relative pose relationship between the first sensor and the second sensor is determined based on pixel positions of the image area.

When the movable platform is manufactured, a dedicated calibration plate is generally used to ensure that the calibration plate appears in the overlapping area of the first sensor and the second sensor. The two sensors will take pictures of the calibration plate respectively, and then the absolute position and angle relationship between the two sensors, that is, the relative pose relationship of the two sensors, is determined. Therefore, when leaving the factory, the relative pose relationship of the two sensors of the movable platform is known and can be obtained from the parameter data recorded by the movable platform body. When calibrating the relative pose between sensors during the manufacturing process, there is a need to control the sensors to take pictures. Since the second sensor has a relatively large viewing angle, the image observed by the second sensor can include the image of the first sensor and the first mounting member where it is located. To certain extent, this image can reflect the relative pose relationship between the first sensor and the second sensor at the position of the second sensor. Therefore, the images calibrated during the manufacturing process can be stored in the memory of the movable platform as reference data for determining the relative pose of the sensors. That is, when leaving the factory, the position of the first sensor of the movable platform in the observation image of the second sensor is also known.

The movable platform may vibrate during operation, and the relative pose relationship between the first sensor and the second sensor may change due to the vibration of the movable platform. For example, during the operation of the movable platform, due to the vibration caused by the motor and the propeller, the first sensor and the second sensor will vibration continuously, resulting in a slight change in the relative pose, especially the relative rotation relationship of the first sensor and the second sensor. Therefore, during use, the image observed by the second sensor can be captured again to observe the image of the first sensor and the first mounting member where it is located can be observed again. In addition, the positions of the first sensor and the second sensor and the first mounting member in the image will change. That is, when in use, the position of the first sensor of the movable platform in the observed image of the second sensor can also be measured.

In addition, when the movable platform is hovering in the air, the movable platform is still in working condition. In order to provide the movable platform with power to hover in the air, the power assemblies of the movable platform, such as motors and propellers, will produce continuous vibrations. Affected by this, the first sensor and the second sensor will also vibrate continuously, causing the relative poses of the first sensor and the second sensor relative to the movable platform body to change. Therefore, even if the movable platform does not move in space, for the same object in space, the pixel position of the object in the observation images of the first sensor and the second sensor may change.

Since the positions of the first sensor of the movable platform in the observation images of the second sensor at the time of leaving the factory and in use are available, by comparing the positions of the first sensor or the first mounting member in the two images, the change in the relative pose relationship between the first sensor and the second sensor from the time of leaving the factory to the time of use can be determined. Since the relative pose relationship between the first sensor and the second sensor of the movable platform when leaving the factory is also available. The relative pose relationship between the first sensor and the second sensor when in use can be determined based on the relative pose relationship between the first sensor and the second sensor of the movable platform when leaving the factory, and the change in the relative pose relationship between the first sensor and the second sensor from the time of leaving the factory to the time of use. In this way, the pose estimation of the movable platform during use can be realized. After the relative pose relationship between the first sensor and the second sensor during use is determined, the depth information of the scene in the observation range of the binocular vision system including the first sensor and the second sensor can be determined based on the relative pose relationship between the first sensor and the second sensor, and the images observed by the first sensor and the second sensor respectively. Based on the determined depth information of the scene, the movable platform can adjust the movement mode to avoid collision with obstacles.

In some embodiments, when comparing the factory and in-use images, a plurality of points with obvious characteristics may be selected on the first mounting member or the first sensor as feature points, and then the positions of the feature points may be identified and marks in the observation images at the time of leaving the factory and the observation images during use. The change in the rotation relationship from factory to use can be determined based on the positions of each feature point in the two images. In order to ensure the accuracy of the results, the selected feature points can be at least three non-colinear points. In addition, in order to obtain a more accurate result, more feature points are generally selected for determination. The present disclosure only takes three feature points as an example, but the number of feature points is not limited in the present disclosure. Since the mounting member and the sensor are fixed structures that do not change arbitrarily, the distance and spatial relative position relationship between each feature point in practice can be measured in advance. Any one of the feature points can be taken as the origin of the coordinates system and its three-dimensional coordinates can be marked as (0, 0, 0), and then the three-dimensional coordinates of the remaining feature points can be determined. After the two-dimensional information of the feature points during use is obtained, the two-dimensional information of the feature points in the image obtained at the factory, that is, the pixel position of the feature points in the image, and the three-dimensional information, that is, the three-dimensional coordinates of the feature points, the change in relative pose between the first sensor and the second sensor during use relative to the factory can be determined using the existing algorithm.

In some embodiments, feature points in factory images may be extracted using feature pint extraction algorithms. In some embodiments, the positions of feature points in the images during use may be determined by using the Kanade-Lucas-Tomasi feature tracker (KLT) algorithm on the factory images. In some embodiments, the perspective-n-point (PnP) algorithm with random sample consensus (RANSAC) may be used to determine the change in the relative pose relationship between the first sensor and the second sensor during use compared to the factory state, that is, the change in the rotation relationship between the first sensor and the second sensor during use. Based on the change in the relative rotation relationship between the first sensor and the second sensor, the relative rotation relationship between the first sensor and the second sensor during use can be determined. Since the displacement change caused by vibration is generally very small and can be ignored, the relative rotation relationship between the first sensor and the second sensor during use can be obtained, that is, the relative pose relationship between the first sensor and the second sensor during use can be obtained.

In some embodiments, in addition to the mounting member and the sensor, a marker pre-set on the first sensor or the first mounting member may also be used as a reference for selecting feature points, and the relative pose relationship between the first sensor and the second sensor may be determined based on the pixel position of the marker in the observation image of the second sensor. In some embodiments, the marker may be disposed at both the first sensor and the second sensor. In order to make the measurement result accurate, the marker is generally fixed on the mounting member or the sensor. In this way, when the movable platform vibrates during movement, even if the relative pose relationship between the sensors changes, the mounting member between the marker and the sensor where it is located can remain unchanged. Since the relative pose relationship between the marker and the sensor where it is located remains unchanged, when determining the change in the relative rotation relationship between the sensor at the time of leaving the factory and at the time of use, the determination can be simplified by determining the relative rotation relationship of the marker at the time of leaving the factory and at the time of use. Generally, the marker has a clear contrast in color and shape with the mounting member, e.g., the arm, and is easier to read as a feature point and it not easy to mark incorrectly. In addition, the marker is a human-designed mark, which is easier to measure the size.

In some embodiments, the marker may be a pattern with a specific meaning such that it can be used to express certain content in addition to estimating the pose. For example, in some embodiments, the marker may be a trademark or a company logo of the manufacturer of the movable platform.

In some embodiments, the marker may also be a barcode (e.g., a one-dimensional barcode, a two-dimensional barcode, etc.), which may display some information related to the movable platform after being scanned.

In some embodiments, due to the viewing angle or pose, the second sensor may not be able to observe the first sensor or the first mounting member. However, by providing a marker on the first sensor or the first mounting member, and the marker is more prominent than the first sensor and the first mounting member, the second sensor can observer the marker. At this time, the change in the relative pose relationship between the first sensor and the second sensor at the time of leaving the factory and at the time of use can be determined by the change in the pixel position of the marker in the image observed by the second sensor.

In some embodiments, if the movable platform measures the relative pose relationship between sensors by using the marker preset on the mounting member or the sensor, then the marker is very important for the pose calibration of the movable platform. If the marker is damaged, the movable platform may be unable to correctly calibrate the relative pose relationship between the cameras when in use, thereby affecting the obstacle avoidance function of the movable platform.

In some embodiments, the second sensor may be disposed at the movable platform through a second mounting member. When the viewing angles of the first sensor and the second sensor on the movable platform are both relatively large, the observation range of the second sensor includes the first mounting member, and the observation range of the first sensor also includes the second mounting member, the images observed by the first sensor and the second sensor can be obtained respectively. Based on the processes shown in FIG. 2, a first relative pose relationship between the first sensor and the second sensor can be determined based on the position of the first mounting member in the observation image of the second sensor, and a second relative pose relationship between the first sensor and the second sensor can be determined based on the position of the second mounting member in the observation image of the first sensor. Subsequently, the relative pose relationship between the first sensor and the second sensor can be determined based on the first relative pose relationship and the second relative pose relationship. In this way, the obtained relative pose relationship is more accurate.

In some embodiments, the relative rotation relationship between the two sensors of the binocular vision system in each direction on the same plane on the movable platform may also be determined respectively. For example, in the movable platform shown in FIG. 1, the relative rotation relationships of the four sensors in the four directions of front, back, left, and right can be respectively multiplied, and the result of the multiplication can be determined based on whether it is the unit matrix I to determine whether the relative pose relationship estimated in each direction is accurate. When the result of multiplying the relative rotation relationships in the four directions of front, back, left, and right is the unit matrix I, the determined relative pose relationship estimation can be considered to be relatively accurate.

In some embodiments, for example, when a sensor in a binocular vision system cannot observe another sensor due to the limitation of viewing angle or pose, or cannot observe a certain marker rigidly connected to another sensor, or when the relative pose relationship determined by the above pose estimation method fails to pass the verification, the above pose estimation method of the movable platform may not be used to estimate the relative pose relationship between sensors. In this regard, an embodiment of the present disclosure provides another method for estimating the post of a movable platform, which can determined the relative pose relationship between the two sensors based on the position relationship and position change of the scene observed by the first sensor and the second sensor multiple times.

FIG. 3 illustrates a flowchart of a pose estimation method of a movable platform according to some embodiments of the present disclosure. The method will be described in detail below.

At 301, a first observation image set is obtained. The first observation image set includes observation images respectively taken by the first sensor and the second sensor at the same time.

At 302, a second observation image set taken by the second sensor is obtained. The second observation image set includes a plurality of observation images taken by the second sensor at different times.

At 303, the relative pose relationship between the first sensor and the second sensor is determined based on the first observation image set and the second observation image set.

In some embodiments, since the movable platform will generate certain vibrations when in use, the relative pose relationship between the first sensor and the second sensor will change to a certain extent. The relative pose relationship between sensors includes relative rotation relationship and relative displacement relationship. Since the displacement change caused by vibration is generally small, the relative displacement relationship does not change much and can be determined based on the displacement relationship measured at the factory and stored on the movable platform. Therefore, when determining the relative pose relationship between sensors, it is mainly determining the relative rotation relationship between sensors. The determination of the relative rotation relationship mainly includes determining the three angles of yaw angle, pitch angle, and roll angle.

In addition, when the movable platform is hovering in the air, the movable platform is still in working condition. In order to provide the movable platform with power to hover in the air, the power assemblies of the movable platform, such as motors and propellers, will produce continuous vibrations. Affected by this, the first sensor and the second sensor will also vibrate continuously, causing the relative poses of the first sensor and the second sensor relative to the movable platform body to change. Therefore, even if the movable platform does not move in space, for the same object in space, the pixel position of the object in the observation images of the first sensor and the second sensor may change. However, the change in the relative pose relationship between sensors caused by vibration is the result of the accumulation of slight changes over a long period of time. In a short period of time, the impact of vibration on the relative pose relationship between sensors is relatively small. Therefore, it can be considered that within a short period of time, the observation images obtained by the sensor at different times are in the same pose. Therefore, the relative pose relationship between sensors can be determined based on multiple observation images obtained at different time in a short period of time.

In some embodiments, since the observation ranges of the first sensor and the second sensor partially overlap, that is, the first sensor and the second sensor can form a binocular vision system, the relative rotation relationship between some sensors can be obtained by comparing the observation positions of the first sensor and the second sensor for the same object in the overlapping area of the observation range. More specifically, the observation images taken by the first sensor and the second sensor at the same time can be obtained respectively. Since the first sensor and the second sensor have partially overlapping observation areas, there are also areas with similar features in the observation images of the first sensor and the observation images of the second sensor. Therefore, the relative rotation relationship between the two images may be determined by matching the feature points in the two images. In some embodiments, before determining the relative rotation relationship, the pitch and roll values calibrated at the factory can be used to perform projection correction on the two observed images such that the corresponding points in the two images can be on corresponding epipolar lines as much as possible when the relative pose relationship remains unchanged. As a result, the impact of the previously calibrated relative pose relationship and the amount of determination can both be reduced. In some embodiments, a feature point tracking and matching algorithm may be used to obtain the feature point pairs in the two images, and then the relative rotation relationship between the two sensors can be determined based on the feature pairs. The relative rotation relationship of two sensors may be determined through a pair of feature points, or multiple relative rotation relationships may be determined through multiple pairs of feature points, and then the relative rotation relationship of the two sensors may be determined based on the multiple relative rotation relationships. In some embodiments, the method of determining the relative rotation relationship between the two sensors based on the feature point pair may include: respectively obtaining a feature point y from the observation image of the first sensor, and a feature point y′ from the observation image of the second sensor to obtain a feature point pair (y, y′); solving the essential matrix to determine the rotation relationship R between the two sensors, R being expressed in the three direction, that is, R=(roll, pitch, yaw).

In some embodiments, in the relative rotation relationship, yaw mainly affects the position of the object in the observed image in the horizontal direction, pitch mainly affects the position of the object in the observed image in the vertical direction, and roll affects both directions. However, since the two sensors are located at a certain distance from each other, even if the relative rotation relationship between the two sensors is zero, the pixel positions of the overlapping areas in the two observed images will be different in the horizontal direction. Therefore, the pitch and roll values in the relative rotation relationship determined based on position difference of the feature point pair in the two images are relatively accurate, but the yaw value will have a relatively large deviation. Therefore, for the relative rotation relationship determined by the observation images taken by the first sensor and the second sensor respectively, only the pitch and roll values are used, and the yaw value needs to be further determined. For example, in some embodiments, after the rotation relationship R is determined by solving the essential matrix, only the roll and pitch values may be used. In the embodiments of the present disclosure, the observation images taken by the first sensor and the second sensor at the same time for determining the pitch and roll in the relative rotation relationship can be regarded as the first observation image set, which is distinguished from other observation images.

In some embodiments, the yaw value in the relative rotation relationship of the sensors may be determined by comparing several images taken by the second sensor at different times and combining these images with the first observation image set. Relative to the first observation image set, a plurality of images captured by the second sensor at different times can be regarded as the second observation image set. The shooting time of each image in the second observation image set may not be earlier than the shooting time of the images in the first observation image set. The shooting time of the images in the first observation image set can be recorded as TO, and the shooting time of each image in the second observation image set will not be earlier than TO. The second observation image set may include an image observed by the second sensor at time TO. The present disclosure only takes a plurality of images taken by the second sensor at different times as the second observation image set for illustration. In fact, another sensor in the binocular vision system, that is, several images taken by the first sensor at different times can also be used as the second observation image set. Based on similar processes, the expected result can also be obtained. In some embodiments, before determining the yaw value, the images in the first observation image set and the second observation image set may be re-projected and corrected using the pitch value and roll value determined by comparing the images captured by the two sensors at the same time.

When the movable platform is moving and the rotation angle of the sensor does not change, for the same observed object, the position of the object in the image observed by the sensor at different times will change regularly. The depth information of the target object may be inferred based on the position change of the object in the observed image and the position change of the movable platform. When the depth information and the values of pitch and roll are known, the yaw value in the relative rotation relationship between the sensors may be inferred based on the binocular vision system. In some embodiments, the feature extraction and feature tracking matching algorithm may be performed sequentially on any image at a time other than TO in the second observation image set and the observation image at TO of the second sensor in the first observation image set or the second observation image set to obtain multiple feature point pairs of the two frames images. For any pair of feature points, due to the depth information, that is, the distance between the object and the movable platform and the size of the object in the observed image are in a certain proportional relationship. Therefore, the depth information of the feature point pair at time TO can be determined based on the ratio of the distances between the feature point pair on the two observation images, and the position change of the movable platform at the corresponding shooting time of the two observation images. Subsequently, the yaw value in the relative rotation relationship between the sensors can be determined.

In some embodiments, for the images captured by the sensor at a first time and a second time, and the feature points x1 and x2, the depth information of the object point corresponding to the feature points x1 and x2 at the first time can be determined based on the following formula.

$$Z 1 = \frac{C}{\frac{m 1}{m 2} - 1}$$

Where Z1 and Z2 represent the depth information of the object point at the first time and the second time, C represents the difference in position information of the movable platform at the first time and the second time, and m1 and m2 represent the distances between the pixels x1 and x2 on the images captured by the sensor at the first time and the second time, respectively. Based on the relative displacement of the movable platform at two times, the difference between Z1 and Z2 can be determined such that Z2 can be expressed using the relationship between Z1 and Z2. For example, in some embodiments, from the first time to the second time, the movable platform moves towards the object points corresponding to x1 and x2. The difference between Z1 and Z2 is the distance the movable platform moves. Then Z2 can be expressed as Z2=Z1+C. Since the depth information, that is, the distance between the object and the movable platform and the size of the object in the observed image are generally inversely proportional, that is, m1/m2=Z2/Z1. Substituting Z2=Z1+C into m1/m2−Z1/Z2, m1/m2=(Z1+C)/Z1. By changing the formula, the formula for determining the depth information is obtained.

In some embodiments, the position information of the movable platform may be obtained through visual-inertial odometry (VIO) or global positioning system (GPS) and IMU.

In some embodiments, the yaw value determined from the images taken at the multiple times can be referred to as the initial value of yaw. In some embodiments, for any pair of feature points, a yaw value can be determined. The yaw value determined by a single feature point pair may be inaccurate. In this case, the yaw value corresponding to each feature point pair can be determined, then the yaw value with the highest probability can be selected as the initial value of yaw through histogram statistics. In some embodiments, the average value of the yaw value corresponding to each feature point pair can also be determined as the initial value of yaw.

In some embodiments, the initial value of yaw determined from the images taken at multiple times may still deviate from the yaw value in the actual relative rotation relationship, therefore, and the yaw value in the relative rotation relationship needs to be further determined. The first observation image set may be used to obtain the feature points matching pairs between the two eyes, while the second observation image set may be used to obtain the feature points matching pairs of images at different times. Through binocular matching, the disparity of each feature point may be determined, and the depth information may be determined to obtain the three-dimensional information of the feature point. Using the PnP algorithm with the RANSAC algorithm, a set of data points containing multiple outliers can be obtained. For this set of data points, a line can be found such that the points on the line, that is, the number of points that fit together, is the largest. The percentage of clustered points to be total number of matched feature points can be considered as the percentage of correct observations. The greater the value, the more accurate the result. In some embodiments, it can be assumed that the yaw value in the relative pose relationship between the sensors during use is within the default value, that is, the yaw value in the relative pose relationship determined at the factory, or the initial value of yaw determined by the above method is within ±3°. That is, various values ±3° of the initial value of yaw can be used in the determination of the above processes to obtain different depth information. Then, different depth information can be determined during the PnP algorithm with the RANSAC algorithm to find the proportion of clustered points. When the proportion of clustered points is the highest, the corresponding yaw value can be regarded as a more accurate yaw value.

In some embodiments, a sliding window may be used to perform bundle adjustment (BA) to solve the jitteriness off the yaw angle and optimize the determined yaw value during use.

Consistent with the present disclosure, based on the first observation image set and the second observation image set, the pitch, roll, and yaw values in the relative rotation relationship between the sensors can be determined in sequence, thereby determining the relative pose relationship between the sensors. After the relative pose relationship between the first sensor and the second sensor during use is determined, the depth information of the scene in the observation range of the binocular vision system including the first sensor and the second sensor can be determined based on the relative pose relationship between the first sensor and the second sensor, and the images observed by the first sensor and the second sensor respectively. Based on the determined depth information of the scene, the movable platform can adjust the movement mode to avoid collision with obstacles.

The present disclosure provides two pose estimation methods for movable platforms. In the first method, when the first sensor has a relatively large viewing angle and can see the other sensor, the relative pose relationship between the sensors can be determined by the position change of the first sensor in the observation image of the second sensor. This method is relatively simple to use, has a fast determination speed, and only requires one frame of image to obtain the result. In the second method, the relative pose relationship between the sensors when in use is determined by using the position relationship and position change of the object points in multiple sets of images taken simultaneously by the first sensor and the second sensor at multiple times. Compared with the first method, the second method does not require the sensor to be able to see another sensor and is more versatile, but it requires multiple frames of images for determination, which takes longer time and is more complicated.

Based on the pose estimation methods for movable platforms, an embodiment of the present disclosure also provides a movable platform. The movable platform can be any of the movable platforms described above, and the movable platform includes a first sensor and a second sensor. In addition, the movable platform also includes a processor for implementing any of the pose estimation methods described in the foregoing embodiments. In some embodiments, when the observation range of the first sensor includes the second sensor, the processor can be configured to implement any embodiment of the first pose estimation method for a movable platform. In some embodiments, regardless of whether the observation range of the first sensor includes the second sensor, the processor can be configured to implement any embodiment of the second pose estimation method for a movable platform.

In addition, the movable platform pose estimation method provided in the embodiments of the present disclosure may also be included in a computer-readable storage medium. The storage medium may be connected to a processing device for executing instructions and stores machine-readable instructions corresponding to the control logic of the pose estimation of the movable platform. These instructions can be executed by the processing device, and the above machine-readable instructions are configured to implement the processes of each embodiment of the pose estimation method of a movable platform provided in the embodiments of the present disclosure. The machine-readable instructions can be used to implement any embodiment of the first pose estimation method of the movable platform, and can also be used to implement any embodiment of the second pose estimation of the movable platform.

In the instant disclosure, relational terms such as “first” and “second,” etc. are used herein merely to distinguish one entity or operation from another entity or operation without necessarily requiring or implying any such actual relationship or order between such entities or operations. The terms “comprise/comprising,” “include/including,” “has/have/having” or any other variants thereof are intended to cover non-exclusive inclusion, so that a process, method, article or device that includes a series of elements includes not only those elements, but also other elements that are not explicitly listed, or also includes elements inherent to such processes, methods, articles, or equipment. If there are no more restrictions, the element associated with a phrase like “comprising a . . . ,” “including a . . . ” does not exclude the presence of additional identical elements in the process, method, article, or equipment that includes the element.

Embodiments of the subject and functional operations described in this specification may be implemented in digital electronic circuits, computer software or firmware in tangible form, computer hardware including the structure disclosed in this specification and its structural equivalents, or one or more combination thereof. Embodiments of the subject described in this specification may be implemented as one or more computer programs, that is, codes that is executed by a data processing device on a tangible non-transitory program carrier or one or more modules of the computer program instructions that control the operation of the data processing device. Alternatively or additionally, the program instructions may be encoded on an artificially-generated propagated signal, such as a machine-generated electrical, optical, or electromagnetic signal. The signal is generated to encode and transmit information to a suitable receiver device to be executed by the data processing device. The computer storage medium may include a machine-readable storage device, a machine-readable storage substrate, a random or serial access memory device, or a combination of thereof.

The processing and logic flow described in this specification may be executed by one or more programmable computers executing one or more computer programs to perform corresponding functions by performing an operation according to input data and generating output. The processing and logic flow may also be executed by a dedicated logic circuit, such as a field-programmable gate array (FPGA) or an application-specific integrated circuit (ASIC), and the device may also be implemented as a dedicated logic circuit.

A computer suitable for executing computer programs includes, for example, a general-purpose and/or special-purpose microprocessor, or any other types of central processing units. Generally, the central processing unit receives instructions and data from a read-only memory and/or a random access memory. The basic components of the computer may include a central processing unit for implementing or executing instructions and one or more storage devices for storing instructions and data. Generally, the computer may also include one or more mass storage devices for storing data, such as a magnetic disk, a magneto-optical disk, or an optical disk, or the computer may be operatively coupled to the mass storage device to receive data from or send data to it, or both situations may exist. However, the computer may not have to have such apparatuses. In addition, the computer may be embedded in another apparatus, such as a mobile phone, a personal digital assistant (PDA), a mobile audio or video player, a game console, a global positioning system (GPS) receiver, or a portable storage device with a universal serial bus (USB) flash drive.

The computer-readable medium suitable for storing the computer program instructions and data may include all forms of non-volatile memory, media, and storage devices, including, for example, a semiconductor memory device (such as erasable programmable read-only memory (EPROM), electrically erasable programmable read-only memory (EEPROM), and flash memory devices), a magnetic disk (such as an internal hard disk or a removable disk), a magneto-optical disk, a CD ROM, and a DVD-ROM disk. The processor and the storage device may be supplemented by or incorporated into a dedicated logic circuit.

Although this specification includes many specific implementation details, they should not be considered a limitation on the scope of any disclosure or the scope of the claimed protection, but are mainly used to describe the features of specific embodiments of the present disclosure. Certain features described in embodiments of the specification may also be implemented in combination in an embodiment. On another hand, various features described in a single embodiment may also be implemented in multiple embodiments separately or in any suitable sub-combination. In addition, although features may work in certain combinations as described above and even initially claimed as such, one or more features from the claimed combination may in some cases be removed from the combination, and the claimed combination may be directed to a sub-combination or a variation of the sub-combination.

Similarly, although operations are described in a specific order in the accompanying drawings, which should not be understood that the operations are required to be performed in the specific order shown or sequentially, or requiring all illustrated operations to be performed to achieve the desired result. In some cases, multitasking and parallel processing may be beneficial. In addition, the separation of various system modules and components of embodiments of the present disclosure should not be understood that such separation is required in all embodiments, and the described program components and systems may usually be integrated together in a single software product, or packaged into multiple software products.

Thus, specific embodiments of the subject matter have been described. Other embodiments are within the scope of the claims. In some cases, the actions described in the claims may be performed in a different order and still achieve the desired result. In addition, the processes described in the accompanying drawings are not necessarily in the specific order or sequential order shown to achieve the desired result. In some embodiments, multitasking and parallel processing may be beneficial.

The methods provided in the embodiments of this application have been described in detail above. Specific examples are used in the disclosure to explain the principles and implementations of the disclosure. The description of the above embodiments is intended to aid in understanding the methods and ideas of the disclosure. For those of ordinary skill in the art, there may be modifications in specific implementations and application scopes based on the ideas of this application. Therefore, the content of this specification should not be understood as limiting the disclosure.

1.-51. (canceled)

52. A pose estimation method comprising:
obtaining an observation image of a second sensor of a movable platform, the movable platform further including a first sensor mounted at the movable platform through a mounting member, an observation range of the second sensor including the mounting member;
determining an image area where the mounting member is located in the observation image; and
determining a relative pose relationship between the first sensor and the second sensor based on a pixel position of the image area.

53. The method of claim 52, wherein the relative pose relationship is configured to change due to vibration of the movable platform during operation.

54. The method of claim 53, wherein a pixel position of an object in space in the observation image is configured to change due to vibration of the movable platform in a hovering state.

55. The method of claim 52, wherein at least one of the first sensor or the second sensor is movably connected to a body of the movable platform.

56. The method of claim 52, wherein:
the movable platform further includes:
a body;
a power assembly; and
a plurality of arms extending outward from the body to support the power assembly; and
the first sensor and the second sensor being respectively mounted at different arms.

57. The method of claim 56, wherein:
at least one arm of the plurality of arms that supports one of the first sensor and the second sensor is movably connected to the body; and
the relative pose relationship is configured to be different when the one arm is in different placement states, the placement states including a retracted state and an extended state.

58. The method of claim 52, wherein an observation range of the first sensor and the observation range of the second sensor at least partially overlap with each other.

59. The method of claim 52, wherein:
the image area includes an image of a preset marker placed on at least one of the mounting member or the first sensor; and
determining the relative pose relationship includes determining the relative pose relationship based on a pixel position of the marker.

60. The method of claim 59, wherein a relative pose relationship between the marker and the first sensor is configured to remain unchanged even when the movable platform vibrates during operation.

61. The method of claim 59, wherein the marker includes a barcode.

62. The method of claim 52,
wherein:
the mounting member is a first mounting member;
the second sensor is disposed at the movable platform through a second mounting member; and
an observation range of the first sensor includes the second mounting member;
the method further comprising:
obtaining an observation image of the first sensor; and
determining an image area where the second mounting member is located in the observation image of the first sensor;
wherein determining the relative pose relationship includes:
determining a first relative pose relationship between the first sensor and the second sensor based on the pixel position of the image area where the first mounting member is located;
determining a second relative pose relationship between the first sensor and the second sensor based on a pixel position of an image area where the second mounting member is located; and
determining the relative pose relationship between the first sensor and the second sensor based on the first relative pose relationship and the second relative pose relationship.

63. The method of claim 52, further comprising:
obtaining an observation image of the first sensor;
determining depth information of a scene in an overlapping observation range based on the relative pose relationship between the first sensor and the second sensor, the observation image of the first sensor, and the observation image of the second sensor; and
controlling movement of the movable platform based on the depth information of the scene.

64. The method of claim 52, wherein the movable platform further includes:
a body; and
an obstacle avoidance assembly mounted at the body, the obstacle avoidance assembly including a plurality of visual sensors distributed in a polyhedron in space, each plane of the polyhedron having at least one of the visual sensors, two visual sensors on different planes constituting a binocular vision system, and an observation range of the binocular vision system being an overlapping range of observation ranges of the two visual sensors.

65. The method of claim 64, wherein the polyhedron is a tetrahedron.

66. The method of claim 65, wherein the tetrahedron is a regular tetrahedron.

67. A pose estimation method comprising:
obtaining a first observation image set, the first observation image set including observation images taken by a first sensor and a second sensor of a movable platform at a same time, and an observation range of the first sensor and an observation range of the second sensor at least partially overlapping with each other;
obtaining a second observation image set taken by the second sensor, the second observation image set including a plurality of observation images taken by the second sensor at different times; and
determining a relative pose relationship between the first sensor and the second sensor based on the first observation image set and the second observation image set.

68. A movable platform comprising:
a body;
an obstacle avoidance assembly mounted at the body and including a plurality of visual sensors distributed in a polyhedron in space, wherein:
each plane of the polyhedron has at least one of the visual sensors;
two visual sensors on different planes constitute a binocular vision system, an observation range of the binocular vision system being an overlapping region of observation ranges of the two visual sensors; and
the two visual sensors of the binocular vision system include:
a first sensor disposed at the body through a mounting member; and
a second sensor, an observation range of the second sensor including the mounting member;
at least one memory storing one or more instructions; and
at least one processor;
wherein the one or more instructions when executed by the at least one processor, cause the movable platform to at least to:
obtain an observation image of the second sensor;
determine an image area where the mounting member is located in the observation image of the second sensor; and
determine a relative pose relationship between the first sensor and the second sensor based on a pixel position of the image area.

69. The movable platform of claim 68, wherein:
the mounting member is a first mounting member;
the second sensor is disposed at the movable platform through a second mounting member;
an observation range of the first sensor includes the second mounting member; and
the one or more instructions when executed by the at least one processor, further cause the movable platform to at least to:
obtain an observation image of the first sensor;
determine an image area where the second mounting member is located in the observation image of the first sensor;
determine a first relative pose relationship between the first sensor and the second sensor based on the pixel position of the image area where the first mounting member is located;
determine a second relative pose relationship between the first sensor and the second sensor based on a pixel position of the image area where the second mounting member is located; and
determine the relative pose relationship between the first sensor and the second sensor based on the first relative pose relationship and the second relative pose relationship.

70. The movable platform of claim 68, wherein the one or more instructions when executed by the processor, further cause the movable platform to:
obtain an observation image of the first sensor;
determine depth information of a scene in an overlapping observation range based on the relative pose relationship between the first sensor and the second sensor, the observation image of the first sensor, and the observation image of the second sensor; and
control movement of the movable platform based on the depth information of the scene.

71. The movable platform of claim 68, wherein the movable platform includes a vehicle, a drone, or a movable robot.
